(19) United States
(12) Patent Application Publication
(10) Pub. No.: US 2015/0138706 A1
(43) Pub. Date: May 21, 2015

(54) SUPPORTING STRUCTURE FOR PORTABLE ELECTRONIC DEVICE

(71) Applicants: Inventec (Pudong) Technology Corporation, Shanghai (CN); INVENTEC CORPORATION, Taipei City (TW)

(72) Inventor: Yun-Tang LIN, TAIPEI CITY (TW)

(73) Assignees: Inventec (Pudong) Technology Corporation, Shanghai (CN); INVENTEC CORPORATION, Taipei City (TW)

(21) Appl. No.: 14/250,390

(22) Filed: Apr. 11, 2014

(30) Foreign Application Priority Data
Nov. 21, 2013 (CN) 201310595141.8

(51) Int. Cl. G06F 1/16

(52) U.S. Cl. CPC G06F 1/1632; G06F 1/1681
USPC 361/679.12; 361/679.44

(57) ABSTRACT

A supporting structure for portable electronic device includes a main body placed on a supporting surface, a supporting plate having a first side and a second side opposite to the first end, and a connecting unit having a first end part, a second end part opposite to the first end, and an electrical connecting element is provided. The first side is pivotally connected with a bottom surface of the main body. The first end part is pivotally connected with a bottom-side of the main body. When the connecting unit performs an opened status, the portable electronic device performs an angle with the main body. When the connecting unit performs a closed status, the portable electronic device is adhered to the main body.

### RELATED APPLICATIONS

This application claims priority to Chinese Application Serial Number 201310595141.8, filed Nov. 21, 2013, which is herein incorporated by reference.

### BACKGROUND

1. Technical Field

The present disclosure relates to a supporting structure for portable electronic device.

2. Description of Related Art

When a conventional portable electronic device is in used, a user often need to touch and control a screen to operate the portable electronic device. When the user combines the portable electronic device with an external device (e.g., an external keyboard) and uses the portable electronic device as using a notebook PC, the portable electronic device often overturns when the user touches and controls it, which is inconvenient to the user. When the external keyboard is adhered to a table, the portable electronic device may be overheating (if the external keyboard is equipped with a high efficiency electrical device). Accordingly, the user may need to buy a heat dissipation device, and bring the heat dissipation device with the external keyboard and the portable electronic device, which is not only uneconomical but also inconvenient.

### SUMMARY

The disclosure provides a supporting structure for portable electronic device includes a main body, a supporting plate, and a connecting unit. The main body is placed on a supporting surface. The supporting plate has a first side and a second side opposite to the first end. The first side is pivotally connected with a bottom surface of the main body. The connecting unit has a first end part, a second end part opposite to the first end, and an electrical connecting element. The first end part is pivotally connected with a bottom-side of the main body. The connecting unit is electrically connected with a portable electronic device through the electrical connecting element. The connecting unit rotates relative to the main body to perform an opened status or a closed status. When the connecting unit performs the opened status, the portable electronic device performs an angle with the main body. When the connecting unit performs the closed status, the portable electronic device is adhered to the main body. During the process that the connecting unit rotates from the closed status to the opened status, the second end part leads the supporting plate to rotate, so that the second side of the supporting plate abuts against the supporting surface and lifts the bottom-side of the main body.

In an embodiment of the present disclosure, the connecting unit includes a pair of connecting ports. The connecting ports are connectively fixed to the connecting unit, so as to be connected with the portable electronic device.

In an embodiment of the present disclosure, the supporting plate includes a first surface and a second surface opposite to the first surface, and the first surface includes an anti-slip pad. When the connecting unit performs the opened status, the second end part of the connecting unit abuts against the anti-slip pad.

In an embodiment of the present disclosure, when the supporting plate performs the closed status, the supporting plate is adhered to the connecting unit.

In an embodiment of the present disclosure, the supporting plate is an arc-shaped plate.

In an embodiment of the present disclosure, the supporting plate includes a first rotary shaft pivotally connected with the bottom surface of the main body.

In an embodiment of the present disclosure, the main body includes a keyboard.

In an embodiment of the present disclosure, the supporting structure for portable electronic device further includes a torsion spring set on the bottom surface of the main body and surrounding the periphery of the first rotary shaft.

In an embodiment of the present disclosure, a cross-section of the connecting unit is semi-elliptical.

In an embodiment of the present disclosure, the connecting unit includes a second rotary shaft pivotally connected with the bottom-side of the main body.

Accordingly, when the connecting unit of the supporting structure for portable electronic device of the disclosure performs the opened status, a pivot between the supporting structure for portable electronic device and the supporting surface changes from the pad to a supporting point, so that when a user touches and controls the portable electronic device, the portable electronic device does not overturn easily. During the process that the connecting unit rotates from the closed status to the opened status, the second end part leads the supporting plate to rotate, so that the second side of the supporting plate abuts to the supporting surface and lifts the bottom-side of the main body, and thus the heat can be dissipated. In addition, the keyboard of the supporting structure can decline to a proper angle for the user to use the keyboard.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view showing that the portable electronic device is joined with the supporting structure for portable electronic device according to an embodiment of the present disclosure;

FIG. 2 is a side view of the supporting structure for portable electronic device according to another embodiment of the present disclosure;

FIG. 3 is a bottom view of the supporting structure for portable electronic device according to another embodiment of the present disclosure;

FIG. 4 is a side view of the connecting unit performing a dosed status according to another embodiment of the present disclosure;

FIG. 5 is a side view of the connecting unit performing an opened status according to another embodiment of the present disclosure;

FIG. 6 is a partial schematic view of the connecting unit, the supporting plate, the torsion spring and the second rotary shaft, and other parts of the supporting structure for portable electronic device according to another embodiment of the present disclosure; and

FIG. 7 is a partial schematic view of the supporting plate at the opened status (the connecting unit is eliminated) according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

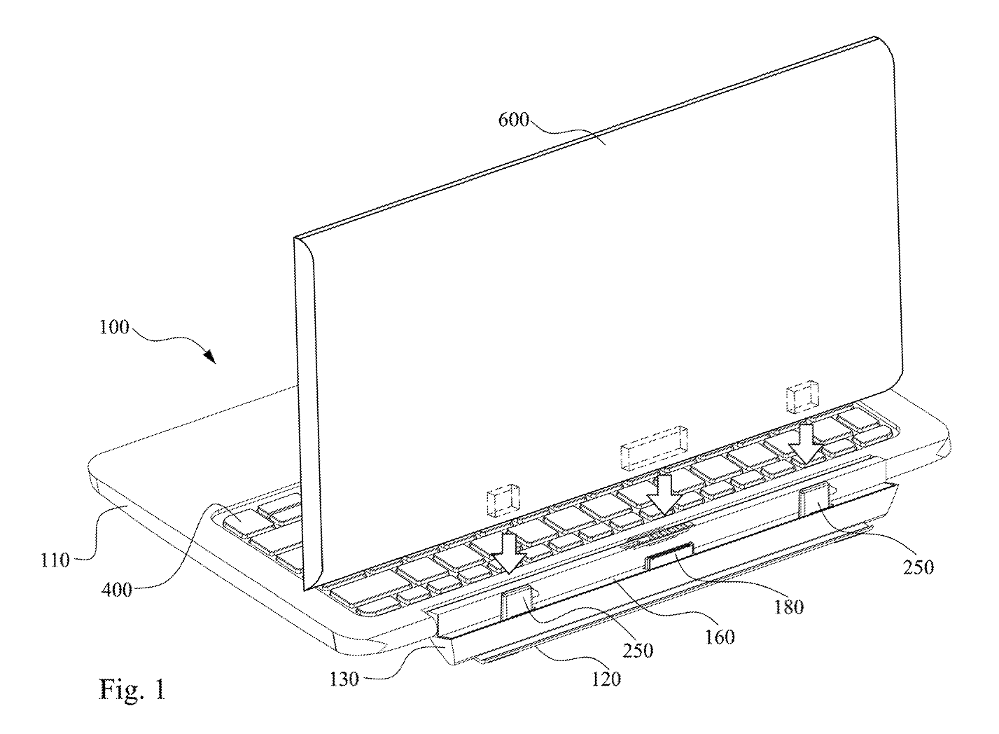

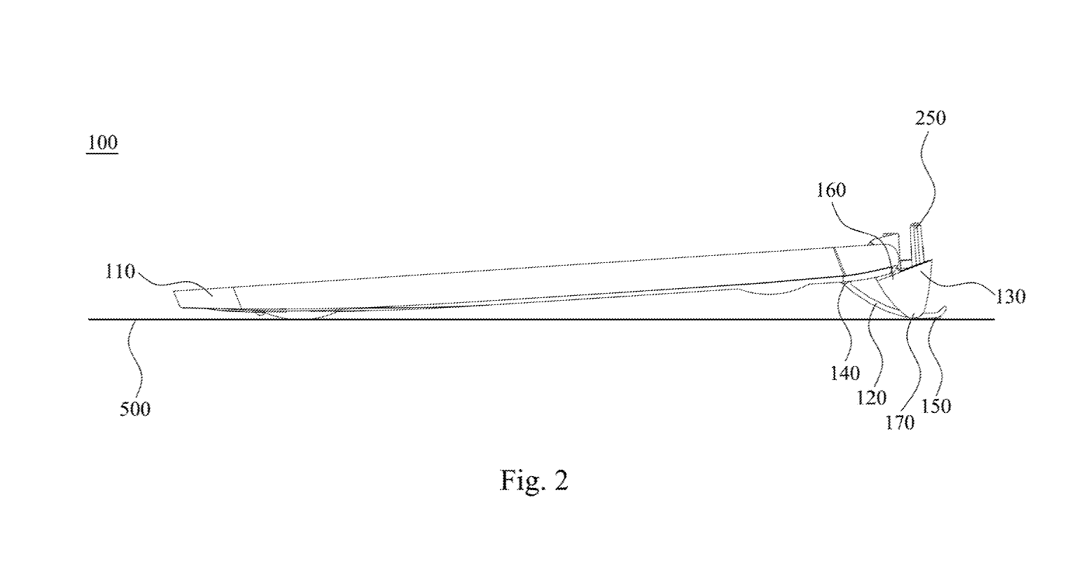

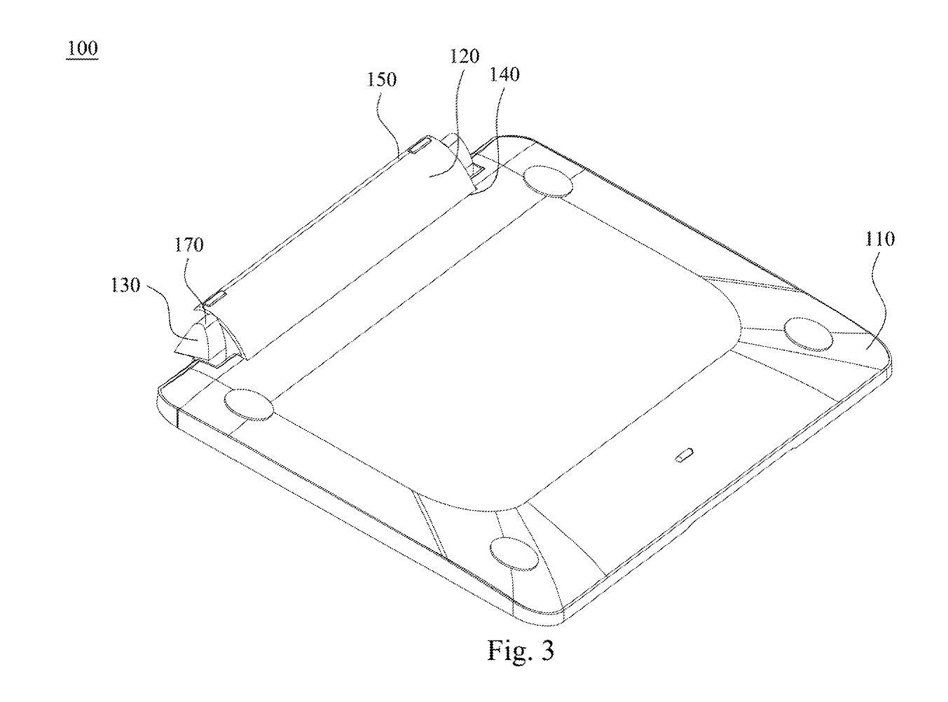

In order to solve a problem that a conventional portable electronic device overturns, the presented disclosure provides a supporting structure for portable electronic device to solve the problem. FIG. 1 is a perspective view showing that the portable electronic device is joined with the supporting structure for portable electronic device according to an embodiment of the present disclosure. FIG. 2 is a side view of the supporting structure for portable electronic device according to another embodiment of the present disclosure. FIG. 3 is a bottom view of the supporting structure for portable electronic device according to another embodiment of the present disclosure. The disclosure provides a supporting structure for portable electronic device 100 that includes a main body 110, a supporting plate 120, and a connecting unit 130. The main body 110 is placed on a supporting surface 500. The supporting plate 120 includes a first side 140 and a second side 150 opposite to the first side 140, and the first side 140 is pivotally connected with a bottom surface of the main body 110. The connecting unit 130 includes a first end part 160, a second end part 170 opposite to the first end part 170 and an electrical connecting element 180. The first end part 160 is pivotally connected with a bottom-side of the main body 110. The connecting unit 130 is electrically connected with a portable electronic device 600 through the electrical connecting element 180. According to another embodiment of the present disclosure, the connecting unit 130 includes a pair of the connecting ports 250, and the connecting ports 250 are connectively fixed to the connecting unit 130, so as to be connected with the portable electronic device 600. According to another embodiment of the present disclosure, the supporting plate 120 is an arc-shaped plate. According to another embodiment of the present disclosure, the main body 110 includes a keyboard 400. According to another embodiment of the present disclosure, a cross-section of the connecting unit 130 is semi-elliptical.

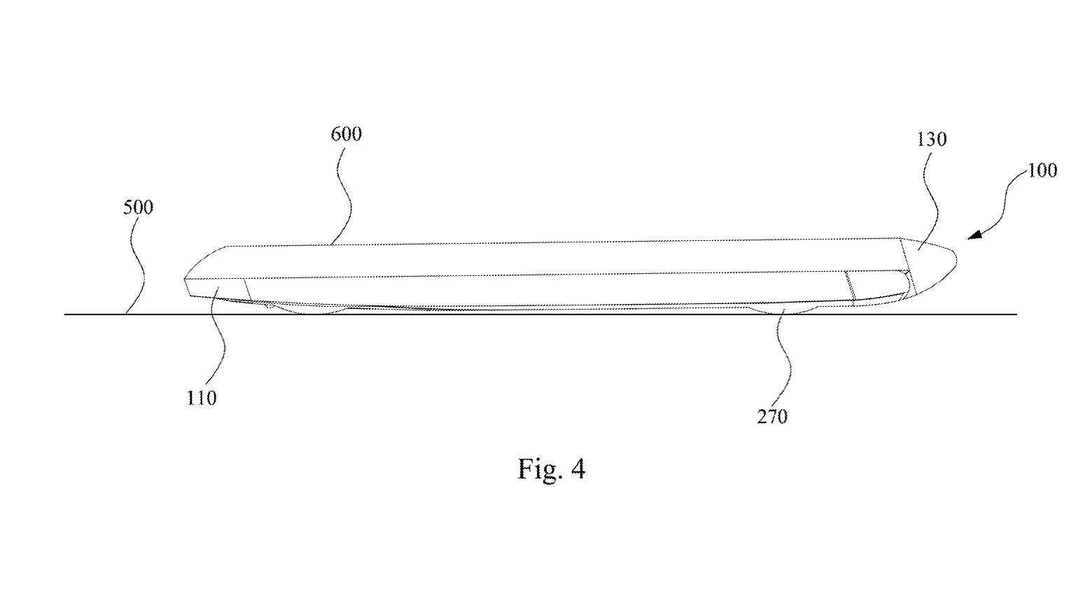

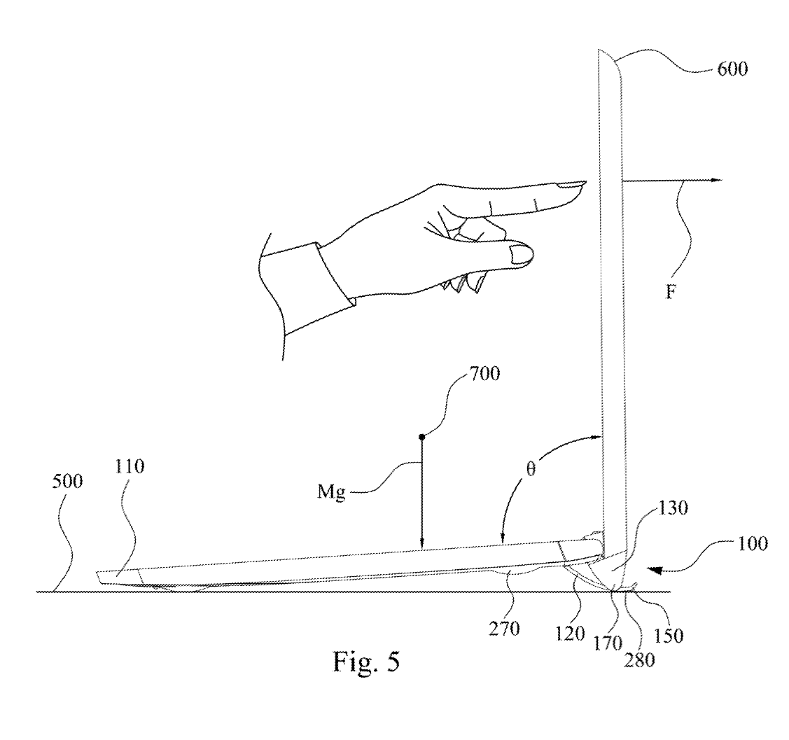

FIG. 4 is a side view of the connecting unit performing a closed status according to another embodiment of the present disclosure. FIG. 5 is a side view of the connecting unit performing an opened status according to another embodiment of the present disclosure. The connecting unit 130 rotates relative to the main body 110 to perform an opened status or a closed status. When the connecting unit 130 performs the opened status, the portable electronic device 600 performs an angle θ with the main body 110. When the connecting unit 130 performs the closed status, the portable electronic device 600 is adhered to the main body 110. During the process that the connecting unit 130 rotates from the closed status to the opened status, the second end part 170 leads the supporting plate 120 to rotate, so that the second side 150 of the supporting plate 120 abuts to the supporting surface 500 and lifts the bottom-side of the main body 110, hence, heat is dissipated, and so that the keyboard 400 of the supporting structure can decline to correspond an angle for user to use the keyboard the angle. When the connecting unit 130 performs the closed status, a pad 270 that is located between the supporting structure for portable electronic device 100 and the supporting surface 500 can be operated as a pivot. When the connecting unit 130 performs the opened status, the pivot between the supporting structure for portable electronic device 100 and the supporting surface 500 changes from the pad 270 to a supporting point 280. The supporting structure for portable electronic device 100 and the portable electronic device 600 have a mass, and the combined center of gravity 700 applies a gravity force Mg. When a user touches and controls the portable electronic device 600, applying a touching force F to the portable electronic device 600. The gravity force Mg and the touching force F achieve static equilibrium through the pivot. When the pivot is the pad 270 (conventional design), the lever arm of the gravity force Mg is shorter, and the touching force F may make the portable electronic device 600 overturn easily. When the pivot is the supporting point 280, the lever arm of the gravity force Mg is longer, and the touching force F is not greater than the torque that the gravity force Mg forms, so that when a user touches and controls the portable electronic device 600, the portable electronic device 600 does not overturn easily.

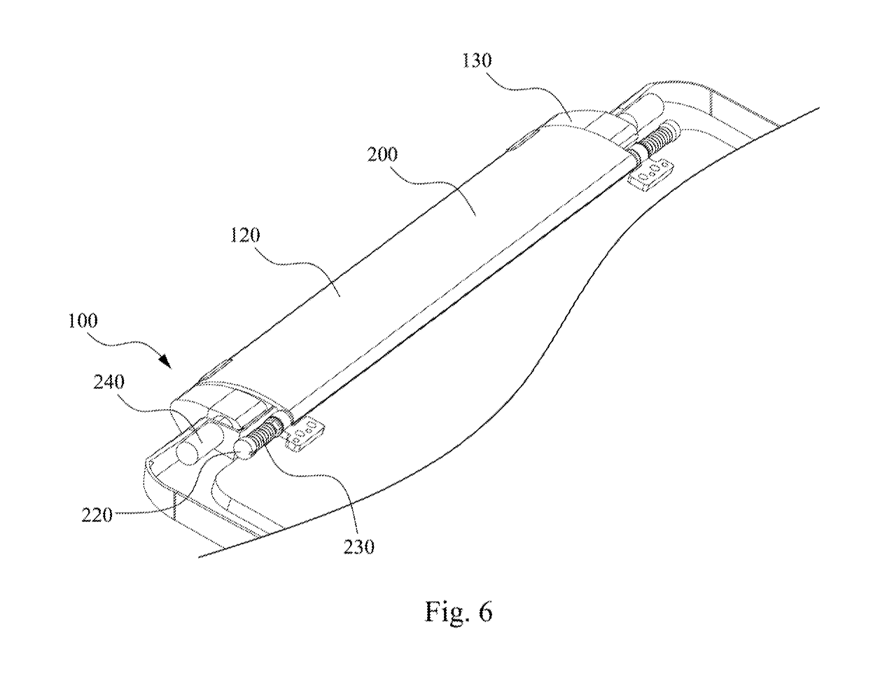

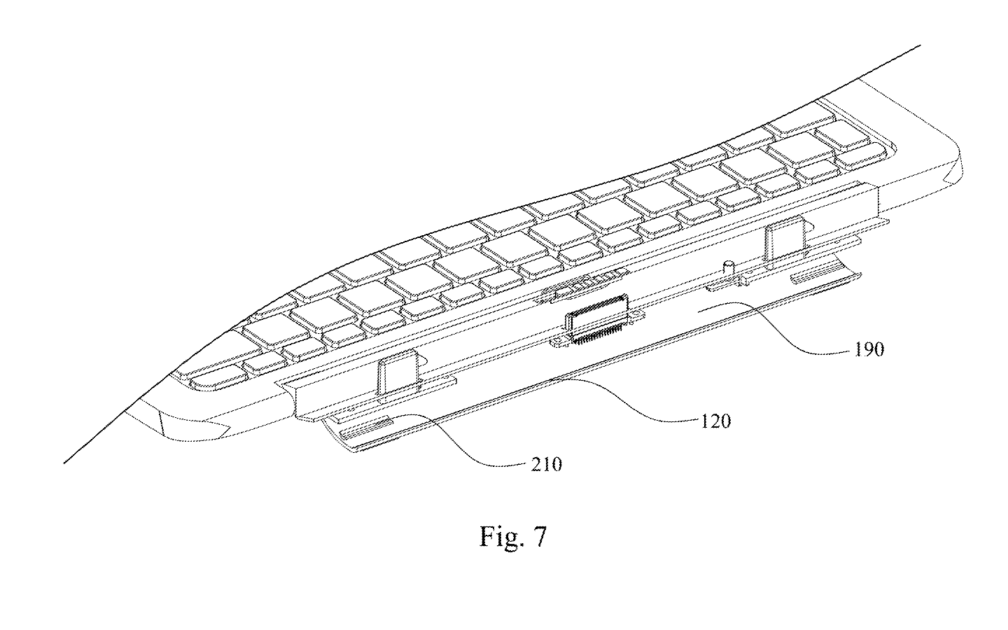

FIG. 6 is a partial schematic view of the connecting unit, the supporting plate, the torsion spring and the second rotary shaft, and other parts of the supporting structure for portable electronic device according to another embodiment of the present disclosure. FIG. 7 is a partial schematic view of the supporting plate at the opened status (the connecting unit is eliminated) according to another embodiment of the present disclosure. The connecting unit 130 is eliminated so as to reveal an anti-slip pad 210 of the first surface 190. According to another embodiment of the present disclosure, the supporting plate 120 includes a first rotary shaft 220, so as to be pivotally connected with the bottom surface of the main body 110. According to another embodiment of the present disclosure, the supporting structure for portable electronic device 100 further includes a torsion spring 230, where the torsion spring 230 is set on the bottom surface of the main body 110, The torsion spring 230 surrounds the periphery of the first rotary shaft 220. The torsion spring 230 is configured to apply a restoring force, so that the supporting plate 120 can rotate to the connecting unit 130 automatically when the supporting plate 120 is at the closed status. According to another embodiment of the present disclosure, the connecting unit 130 includes a second rotary shaft 240 pivotally connected with the bottom-side of the main body 110. According to another embodiment of the present disclosure, the supporting plate 120 includes a first surface 190 and a second surface 200 opposite to the first surface 190, and the first surface 190 includes an anti-slip pad 210. When the connecting unit 130 performs the opened status (referring to FIG. 5), the second end part 170 of the connecting unit 130 (referring to FIG. 5) abuts against the anti-slip pad 210 on an inner surface of the supporting plate 120 (the first surface 190). According to another embodiment of the present disclosure, when the supporting plate 120 is at the closed status, the supporting plate 120 is adhered to the connecting unit 130.

Accordingly, when the connecting unit of the supporting structure for portable electronic device of the disclosure performs the opened status, a pivot between the supporting structure for portable electronic device and the supporting surface changes from the pad to a supporting point, so that when a user touches and controls the portable electronic device, the portable electronic device does not overturn easily. During the process that the connecting unit rotates from the closed status to the opened status, the second end part leads the supporting plate to rotate, so that the second side of the supporting plate abuts to the supporting surface and lifts the bottom-side of the main body, and thus the heat can be dissipated. In addition, the keyboard of the supporting structure can decline to a proper angle for the user to use the keyboard.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A supporting structure for portable electronic device, comprising:
a main body placed on a supporting surface;
a supporting plate having a first side and a second side opposite to the first side, wherein the first side is pivotally connected with a bottom surface of the main body; and
a connecting unit having a first end part, a second end part opposite to the first end part, and an electrical connecting element, the first end part being pivotally connected with a bottom-side of the main body, the connecting unit being electrically connected with a portable electronic device through the electrical connecting element, the connecting unit rotating relative to the main body to perform an opened status or a closed status, wherein when the connecting unit performs the opened status, the portable electronic device performs an angle with the main body, when the connecting unit performs the closed status, the portable electronic device is adhered to the main body, and during the process that the connecting unit rotates from the closed status to the opened status, the second end part leads the supporting plate to rotate, so that the second side of the supporting plate abuts against the supporting surface and lifts the bottom-side of the main body.

2. The supporting structure for portable electronic device of claim 1, wherein the connecting unit comprises a pair of connecting ports, the connecting ports are connectively fixed to the connecting unit, so as to be connected with the portable electronic device.

3. The supporting structure for portable electronic device of claim 1, wherein the supporting plate comprises a first surface and a second surface opposite to the first surface, the first surface comprises an anti-slip pad, when the connecting unit performs the opened status, the second end part of the connecting unit abuts against the anti-slip pad.

4. The supporting structure for portable electronic device of claim 1, wherein when the supporting plate performs the closed status, the supporting plate is adhered to the connecting unit.

5. The supporting structure for portable electronic device of claim 1, wherein the supporting plate is an arc-shaped plate.

6. The supporting structure for portable electronic device of claim 1, wherein the supporting plate comprises a first rotary shaft pivotally connected with the bottom surface of the main body.

7. The supporting structure for portable electronic device of claim 1, wherein the main body comprises a keyboard.

8. The supporting structure for portable electronic device of claim 1, further comprising a torsion spring set on the bottom surface of the main body and surrounding the periphery of the first rotary shaft.

9. The supporting structure for portable electronic device of claim 1, wherein a cross-section of the connecting unit is semi-elliptical.

10. The supporting structure for portable electronic device of claim 1, wherein the connecting unit comprises a second rotary shaft pivotally connected with the bottom-side of the main body.
